(19) United States
(12) Patent Application Publication
(10) Pub. No.: US 2013/0150039 A1
(43) Pub. Date: Jun. 13, 2013

(54) HANDOVER RESTRICTION

(71) Applicants: Peter Ramle, Molnlycke (SE); Maud Forsman, Vargon (SE); Mathias Johansson, Vastra Frolunda (SE)

(72) Inventors: Peter Ramle, Molnlycke (SE); Maud Forsman, Vargon (SE); Mathias Johansson, Vastra Frolunda (SE)

(73) Assignee: Telefonaktiebolaget L M Ericsson (publ), Stockholm (SE)

(21) Appl. No.: 13/326,947

(22) Filed: Dec. 15, 2011

Related U.S. Application Data
(63) Continuation of application No. PCT/EP2011/072430, filed on Dec. 12, 2011.

(51) Int. Cl. H04W 36/00

(52) U.S. Cl. 455/436

(57) ABSTRACT

This disclosure is directed to a source radio access node and a method in the source radio access node for executing a handover of a radio terminal 315 to a target neighboring radio access node 316b from the source radio access node being controlled by a mobility management node 310, which method comprises the actions of: obtaining 401 topology data TD comprising information indicative of at least one neighboring radio access node 316b, 316c that is neighboring with respect to the source radio access node 316a, and providing 402 the topology data to the mobility management node, and receiving 404 from the mobility management node a filtered restriction list FRL comprising information indicative of at least one restricted neighboring radio access node 316c for the radio terminal, enabling a handover decision 405 to be made based on the filtered restriction list FRL.

### TECHNICAL FIELD

This disclosure relates to handover restrictions in connection with handover between access nodes in a communication network.

### BACKGROUND

FIG. 1 illustrates a well known exemplifying architecture for 3GPP accesses within an Evolved Packet System (EPS). Here, a User Equipment (UE) may interact with the EPS via the LTE-Uu interface using the radio access resources of the Evolved Universal Terrestrial Radio Access Network (E-UTRAN). The UE-related handover and control signalling is handled by the Mobility Management Entity (MME) via the S1-MME interface, typically supported by subscription information provided by the Home Subscriber Server (HSS). User payload is handled by the Serving Gateway (SGW) and the PDN Gateway (PGW) via the S1-U and S5 interfaces. The PGW may interact with a Policy and Charging Rules Function (PCRF) via the Gx interface.

During periods when the UE is not interacting with the Evolved Packet Core (EPC) of the EPS it is set into the state IDLE. The EPC comprises at least the MME, the SGW and the PGW. The UE may start to interact with the EPC by executing an E-UTRAN attach procedure. In E-UTRAN the attach procedure includes the setup of a Packet Data Network connection (PDN-connection), which results in an activated default bearer for the UE. The attach procedure brings the UE into the state ECM-CONNECTED, and in that state the Mobility Restriction functionality is executed in the radio network (E-UTRAN) and in the EPC.

As a part of the Mobility Restriction functionality the EPC provides the E-UTRAN with a Handover Restriction List (HRL) for the UE. The HRL may e.g. have the content and layout as defined in the Information Element (IE) indicated for the handover restriction list in chapter 9.2.1.22 of the specification 3GPP TS 36.413 v10.1.0 (2011-03). Thus, the HRL may e.g. specify roaming and/or access restrictions etc that restricts the mobility of the UE in question.

The Intra-E-UTRAN mobility for a UE in state ECM-CONNECTED is typically executed by either using a X2-based handover procedure or a S1-based handover procedure. The X2-based handover is typically used for handover between two evolved NodeBs (eNB) when the eNBs are set up to communicate via an X2-interface. The S1-based handover is used for handover between two eNBs when no X2-interface is present between the eNBs. The S1-handover procedure may also be used for handover between a first eNB controlled by a first MME and a second eNB controlled by a second MME. Inter RAT mobility for a UE in state ECM-CONNECTED uses the IRAT Handover procedure, possibly combined with the CSFB or SRVCC procedure.

By providing a radio access network (e.g. an E-UTRAN) with a Handover Restriction List (HRL) as indicated above it is possible to prevent a handover already at the source RAN-node (e.g. the source eNB) instead of initiating a handover that may eventually be rejected by a core network node (e.g. the MME). Preventing a handover already at the source RAN-node saves signaling and processing resources in the system. This is especially valuable for an X2-based handover between two eNBs, since such a handover will be almost completed before it is rejected by the MME. Moreover, a late rejection may also force the rejected UE into an idle mode losing its contact with the EPC, instead of remaining connected at source eNB. This problem is accentuated when a break-before-make approach is used in the handover procedure.

An effective abortion of a handover attempt at the source RAN-node requires that the source RAN-node is aware of the restrictions for the radio terminal to be handed over. Thus, a Handover Restriction List (HRL) comprising all the restrictions for the radio terminal to be handed over is sent to the source RAN-node from the core network node controlling the source RAN-node. More particular, in the EPS a Handover Restriction List (HRL) comprising all the restrictions for the UE to be handed over is sent to the source eNB from the MME controlling the source eNB. Here, the HRL comprises all the Tracking Areas (TA) and/or Location Areas (LA) or similar areas that are restricted for the UE in all Public Land Mobile Networks (PLMN). Note that a TA and an LA or similar area may comprise one or several RAN nodes. In other words, a TA and an LA may correspond to one or several RAN nodes. It follows that all RAN nodes in a restricted TA or a restricted LA are restricted.

Before proceeding should be explained that the lines and arrows or similar connecting the different nodes, units and/or equipments and similar arrangements in FIG. 1 illustrate an exemplifying connectivity between these arrangements. The short lines labeled Gi, Gx, LTE-Uu, Rx, SGi, S1-U, S1-MME, S1-U, S3, S4, S5, S5/S8, S6a, S10, S11, S12 and Uu etc are in correspondence with the 3GPP specifications and illustrate that logical interfaces with the corresponding names are used for communication between said arrangements by means of said connectivity.

FIG. 2 shows a single schematic Public Land Mobile Network (PLMN) 210 where a radio terminal 315 (e.g. an UE) is only allowed into the outer part of the PLMN 210, but is restricted in the inner part 220 of the PLMN 210. Here, the handover restriction list (HRL) for the radio terminal 315 to be handed over from radio access node 316a to radio access node 316b will comprise all the restricted Tracking Areas (TA) and/or Location Areas (LA) or similar areas in the inner part 220 of the PLMN 210 comprising a multitude of TA and/or LA or similar. The data in the handover restriction list HLR may sum up to an enormous amount, particularly considering that an ordinary PLMN comprises a huge number of TA:s and/or LA:s or similar, and considering that a large part of the PLMN may be restricted for the UE in question. This situation may e.g. occur when a network operator within a PLMN both share a RAN with another operator and have an exclusive RAN. A roaming radio terminal may then be allowed in the smaller exclusive part while being restricted in the larger shared part, with the effect that the handover restriction list HLR for the UE in question will comprise a very large amount of data. The problem is tripled in magnitude if we also consider surrounding 2G/3G-networks that may have partial restrictions in the PLMN 210 and/or in the inner part 220 of the PLMN 210. In such case, the problem is also there for the number of forbidden 2G LACs and forbidden 3G LACs that the MME might have to send to eNB to prevent IRAT handover to restricted areas.

In view of the above there seems to be a need for an improved scheme for effectively accomplishing an abortion of a handover attempt at the source RAN-node.

### SUMMARY

Embodiments of the present solution are based on the observation that a Handover Restriction List (HLR) is most useful with respect to source and target radio access nodes (e.g. source eNB:s and/or target eNB:s) that are located at the border area between permitted areas and restricted areas. The permitted areas and restricted areas may e.g. be divided into TA:s and/or LA:s or similar corresponding to one or several radio access nodes

However, there is no method in the current 3GPP specifications assuring that the distribution of a Handover Restriction List (HLR) is limited to source radio access nodes (e.g. source eNB:s) that are located at the border area between permitted areas and restricted areas.

On the contrary, in the EPS the MME has no knowledge about the geography of the network (specifically which eNBs that are located close to each other), and a Handover Restriction List (HRL) comprising all the restrictions for the UE to be handed over is therefore sent from the MME to the source eNB controlling the source eNB. Moreover, such a HRL is sent to every source eNB, even if the location of the source eNB is such that it can only make a handover of an UE to a permitted target eNB. Similarly, a HRL is sent to every source eNB, even if there is no change with respect to the previously sent HRL.

To this end, this specification discloses a method in a source radio access node for executing a handover of a radio terminal to a target neighboring radio access node from the source radio access node being controlled by a mobility management node. The method comprises the actions of: obtaining topology data TD comprising information indicative of at least one neighboring radio access node that is neighboring with respect to the source radio access node; and providing the topology data to the mobility management node; and receiving from the mobility management node a filtered restriction list FRL comprising information indicative of at least one restricted neighboring radio access node for the radio terminal, enabling a handover decision to be made based on the filtered restriction list FRL.

In addition, this specification discloses a source radio access node being controlled by a mobility management node and configured to operatively execute a handover of a radio terminal to a target neighboring radio access node from the source radio access node. The source radio access node comprises an obtaining unit configured to operatively obtain topology data TD comprising information indicative of at least one neighboring radio access node that is neighboring with respect to the source radio access node, and a providing unit configured to operatively provide the topology data to the mobility management node, and a receiving unit configured to operatively receive from the mobility management node a filtered restriction list FRL comprising information indicative of at least one restricted neighboring radio access node for the radio terminal, enabling a handover decision to be made based on the filtered restriction list FRL.

Moreover, this specification discloses a mobility management node configured to operatively manage a handover of a radio terminal from a source radio access node to a target neighboring radio access node. The mobility management node comprises a receiving unit configured to operatively receive topology data TD from the source radio access node comprising information indicative of at least one neighboring radio access node that is neighboring with respect to the source radio access node, and a producing unit configured to operatively produce, based on the topology data TD, a filtered restriction list FRL comprising information indicative of at least one restricted neighboring radio access node for the radio terminal, and a providing unit configured to operatively provide the filtered restriction list FRL to the source radio access node so as to enable the source radio access node to make a handover decision based on the filtered restriction list FRL.

Further advantages of the present invention and embodiments thereof will appear from the following detailed description of the invention.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

FIG. 1 is a schematic illustration of a known exemplifying architecture for 3GPP accesses within an Evolved Packet System (EPS),

FIG. 2 is a schematic illustration of an exemplifying PLMN 210 wherein an radio terminal is only allowed into the outer part of the PLMN 210, but is restricted in the inner part 220 of the PLMN 210,

FIG. 3a is a schematic illustration of an exemplifying architecture for radio access within a wireless communication system 300 according to an embodiment of the present solution,

FIG. 3b is a schematic illustration showing details of the source radio access node 316a and the mobility management node 310 of the system 300 in FIG. 3a being relevant for embodiments of the present solution,

FIG. 4 is a flowchart illustrating a method according to an exemplifying embodiment of the present solution,

FIG. 5 is a signaling diagram illustrating the method in FIG. 4,

FIG. 6a is a signaling diagram illustrating another embodiment of the method in FIGS. 4 and 5 executed in connection with an attachment procedure,

FIG. 6b is a signaling diagram illustrating another embodiment of the method in to FIGS. 4 and 5 executed in connection with a TAU-procedure,

FIG. 6c is a signaling diagram illustrating another embodiment of the method in to FIGS. 4 and 5 executed in connection with a service request procedure,

FIG. 6d is a signaling diagram illustrating another embodiment of the method in to FIGS. 4 and 5 executed in connection with a X2 handover procedure,

FIG. 6e is a signaling diagram illustrating another embodiment of the method in to FIGS. 4 and 5 executed in connection with a S1 handover procedure.

### DETAILED DESCRIPTION

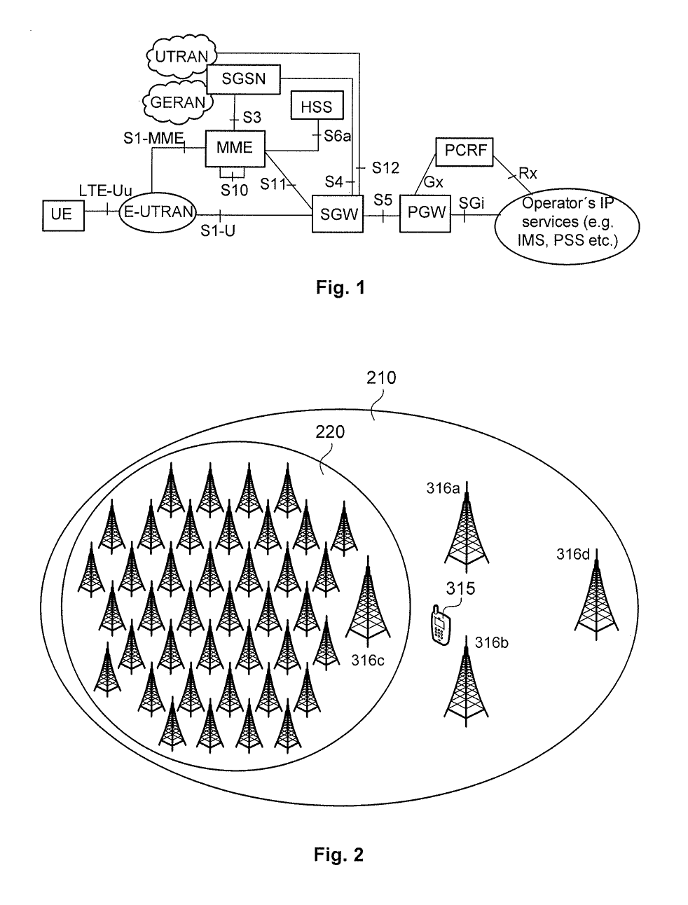

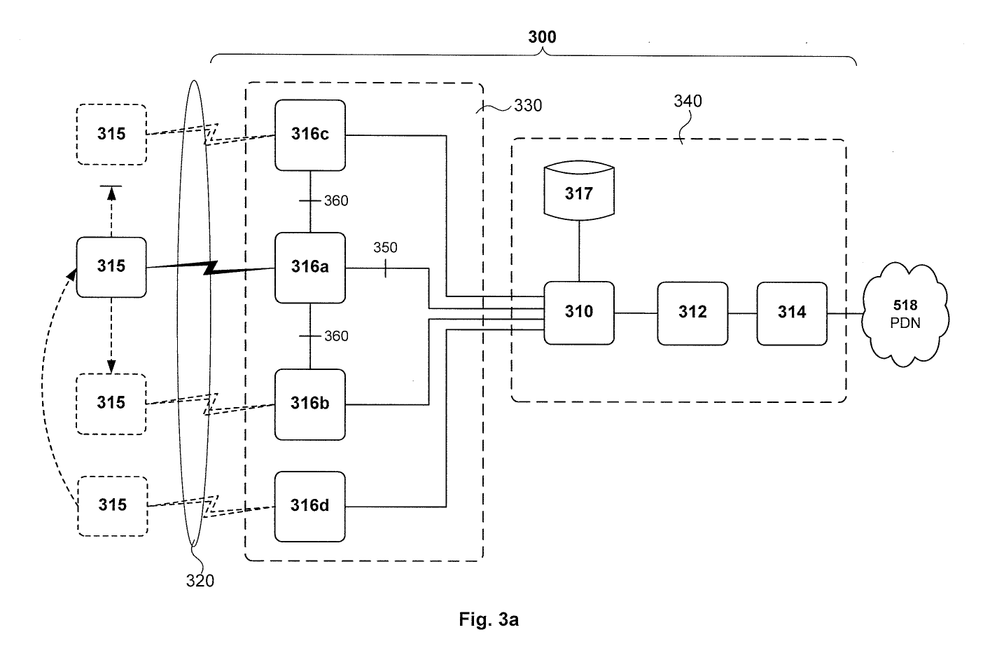

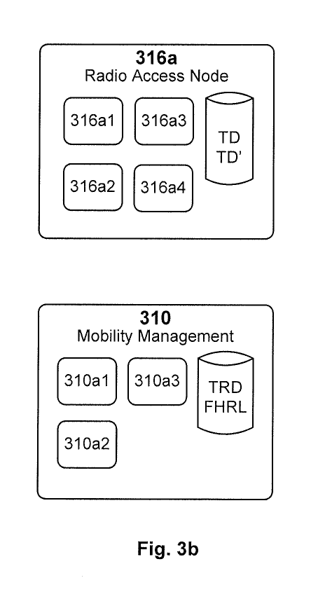

FIG. 3a illustrates an exemplifying architecture for radio access within a wireless communication system 300 according to an embodiment of the present solution. As will be described in more detail below, embodiments of the present solution may e.g. be based on the communication system 300 in the form of an cellular communication system, e.g. such as an LTE-system e.g. of the same or similar kind as illustrated in FIG. 1, or any other wireless communication system according to the 3GPP specifications or similar, e.g. a GSM-system, or a GPRS-system, or a EDGE-system, or a WCDMA-system, or a HSPA-system or similar. Indeed, the system 300 may even be a WiMAX-system (e.g. as in IEEE 802.16e or in IEEE 802.16m) or even a WiFi-system (e.g. as in IEEE 802.11 or similar), or a MIFI-system or similar. The system 300 may control the PLMN 210 described above with reference to FIG. 2.

The wireless communication system 300 may comprise a plurality of mobile radio terminals such as the radio terminal 315 indicated in FIG. 3, and a plurality of radio access nodes 316a, 316b, 316c and 316d, and at least one mobility management node 310 configured to control the mobility for one or several radio terminals between the radio access nodes 316a, 316b, 316c and/or 316d. In addition, the operation of the mobility management node 310 may be supported by other network nodes, e.g. by a serving gateway (SGW) node 312 or similar configured to route and/or forward user traffic or similar (e.g. such as user data packets or similar) for radio terminals of the system 300, and/or a home subscriber server (HSS) 317 or similar containing user-related and/or subscription-related information or similar for radio terminals of the system 300, and/or a packet data network gateway (PGW) 314 configured to provide connectivity from one or more radio terminals of the system 300 to external packet data networks (PDN) 518 or similar by being the point of exit and entry of traffic for the radio terminal(s).

The radio terminal 315 of the system 300 is preferably configured to operatively communicate with one or several radio access nodes 316a, 316b, 316c and 316d of the system 300 using an air interface 320 to access resources provided by the system 300. A skilled person having the benefit of this disclosure realizes that vast number of well known radio terminals can be used in the various embodiments of the present solution. The radio terminal 315 may e.g. be a cell phone device or similar, e.g. such as a Mobile Station (MS) or a User Equipment (UE) or similar, e.g. defined by the standards provided by the 3GPP. Thus, the radio terminal 315 needs no detailed description as such. However, it should be noted that the mobile radio terminal 315 may be embedded (e.g. as a card or a circuit arrangement or similar) in and/or attached to various other devices, e.g. such as various laptop computers or tablets or similar or other mobile consumer electronics or similar, or vehicles or boats or air planes or other movable devices, e.g. intended for transport purposes. Indeed, the radio terminal 315 may even be embedded in and/or attached to various semi-stationary devices, e.g. domestic appliances or similar, or consumer electronics such as printers or similar having a semi-stationary mobility character.

With respect to the air interface 320 it can be noted that a skilled person having the benefit of this disclosure realizes that vast number of well known air interfaces can be used in the various embodiments of the present solution. The air interface 320 may e.g. be a Uu-interface or similar defined by the 3GPP standards. Thus, the air interface 320 needs no detailed description as such.

The radio access node 316a of the system 300 is preferably configured to operatively communicate via the air interface 320 with one or several radio terminals such as the radio terminal 315 so as to give the radio terminals access to resources provided by the system 300. The radio access node 316a is also configured to operatively communicate with the mobility management node 310 using a network node interface 350. In addition, the radio access node 316a is configured to operatively communicate with neighboring radio access nodes using an access node interface 360. The radio access node 316a may be a part of the radio access network 330 of the system 300. The radio access network 330 comprises the radio access nodes 316a, 316b, 316c and 316d. The basic structure and function of various radio access nodes, such as the radio access node 316a, are well known per se to those skilled in the art and the basic structure and function of various embodiments of the radio access node 316a need no detailed description as such. The radio access node 316a may e.g. be a radio base station or similar e.g. such as Base Transceiver Station (BTS) or a NodeB (NB) or an eNodeB (eNB) or similar, or a Base Station Controller (BSC) or a Radio Network Controller (RNC) or similar, e.g. defined by the standards provided by the 3GPP or similar. The other radio access nodes 316b, 316c and 316d shown in FIG. 3 may be of the same or similar kind as the radio access node 316a.

Various suitable network interfaces such as the network node interface 350 suitable for communicating information between a radio access node and a mobility management node are well known per se to those skilled in the art and the network node interface 350 needs no detailed description as such. The network node interface 350 may e.g. be a wired or a wireless interface. The network node interface 350 may e.g. be a S1-MME interface or similar defined by the 3GPP standards or similar.

Various suitable access interfaces such as the access node interface 360 suitable for communicating information between two radio access nodes are well known per se to those skilled in the art and the access node interface 360 needs no detailed description as such. The access node interface 360 may e.g. be a wired or a wireless interface. The access node interface 360 may e.g. be an X2-interface or similar defined by the 3GPP standards or similar.

Before proceeding it should be emphasized that the radio access node 316a is additionally configured according to embodiments of the present solution, as will be elaborated in more detail below.

As can be seen in FIG. 3b, it is preferred that the source radio access node 316a comprises an obtaining unit 316a1 configured to operatively obtain topology data TD comprising information indicative of at least one neighboring radio access node 316b, 316c that is neighboring with respect to the source radio access node 316a, and a providing unit 316a2 configured to operatively provide the topology data TD to the mobility management node 310, and a receiving unit 316a3 configured to operatively receive from the mobility management node 310 a filtered restriction list FRL comprising information indicative of at least one restricted neighboring radio access node 316c for the radio terminal, enabling a handover decision to be made by the radio access node 316a based on the filtered restriction list FRL. Not that the source radio access node 316a may comprise both the most recently obtained topology data TD and a previously obtained topology data TD′. The most recently obtained topology data TD and the previously obtained topology data TD′ are both comprising information indicative of topology data, however, received at different times by the source radio access node 316a. The previously obtained topology data TD′ may e.g. be the last topology data that was obtained before the most recently obtained topology data TD.

In addition, as will be elaborated in more detail later, it is preferred that the source radio access node 316a comprises a handover decision unit 316a4 configured to operatively make a handover decision based on the filtered restriction list FRL in connection with a handover attempt of the radio terminal 315 from the source radio access node 316a to the target neighboring radio access node 316b such that the attempt is aborted when the target neighboring radio access node 316b is indicated in the filtered restriction list FRL and approved for further processing when the target neighboring radio access node 316b is not indicated in the filtered restriction list FRL.

The units 316a1, 316a2, 316a3, 316a4 now mentioned may be implemented by means of software and/or hardware. The units 316a1, 316a2, 316a3, 316a4 may have processing and storage capability configured to execute computer program instruction sets for performing signaling with other nodes in the system 300.

The mobility management node 310 of the system 300 is configured to operatively control the mobility of the radio terminal 315 when moving between the radio access nodes 316a, 316b, 316c and/or 316d of the system 300. This may e.g. include supervising and control of a handover of the radio terminal 315 between two radio access nodes. As already indicated above, the mobility management node 310 is also configured to operatively communicate with the radio access node 316a using the network node interface 350. The mobility management node 310 may be a network node, e.g. a core network node of a core network 340 of the system 300. As can be seen in FIG. 3a, the core network 340 of the system 300 comprises the mobility management node 310 and preferably also the serving gateway 312 and/or the home subscriber server 317 mentioned above. The basic structure and function of various mobility management nodes are well known per se to those skilled in the art and the basic structure and function of the network mobility management node 310 need no detailed description as such. For example, the network mobility management node 310 may be a Mobility Management Entity (MME) or similar defined by the standards provided by the 3GPP.

Indeed, an MME may be responsible for the overall mobility in the system 300. When a UE registers, the MME will request subscriber data from the home subscriber server 317 and perform an authentication of the UE. The MME will also take care of signaling to and from the UE by means of a signaling protocol, commonly referred to as Non Access Stratum (NAS) signaling. When new bearers are to be established or existing bearers are modified for the UE, the MME will communicate this with the Serving Gateway 312. The bearers are commonly referred to as EPS bearers or PDN connections, wherein each PDN connection may comprise one or several EPS bearers. When the UE is registered to the MME, then the MME will handle all paging functions and mobility management functions (e.g. such as tracking area updates etc). If the UE registers in a foreign network, then the MME or similar that is located in that network will obtain subscriber data from the home subscriber server 317 in the home network 300. This is referred to as roaming functions. The same applies mutatis mutandis to other mobility management nodes according to embodiments of the present solution.

Even if various mobility management nodes are well known to those skilled in the art it should be emphasized that the mobility management node 310 is additionally configured according to embodiments of the present solution, as will be elaborated in more detail below.

As can be seen in FIG. 3b, it is preferred that the mobility management node 310 comprises a receiving unit 310a1 configured to operatively receive topology data TD from the source radio access node 316a which topology data TD comprises information indicative of at least one neighboring radio access node 316b, 316c that is neighboring with respect to the source radio access node 316a, and a producing unit 310a2 configured to operatively produce, based on the received topology data TD, a filtered restriction list FRL comprising information indicative of at least one restricted neighboring radio access node 316c for the radio terminal 315, and a providing unit 310a3 configured to operatively provide the filtered restriction list FRL to the source radio access node 316a enabling the source radio access node 316a to make a handover decision based on the filtered restriction list FRL. The units 310a1, 310a2, 310a3 may be implemented by means of software and/or hardware. The units 310a1, 310a2, 310a3 may have processing and storage capability configured to execute computer program instruction sets for performing signaling with other nodes in the system 300.

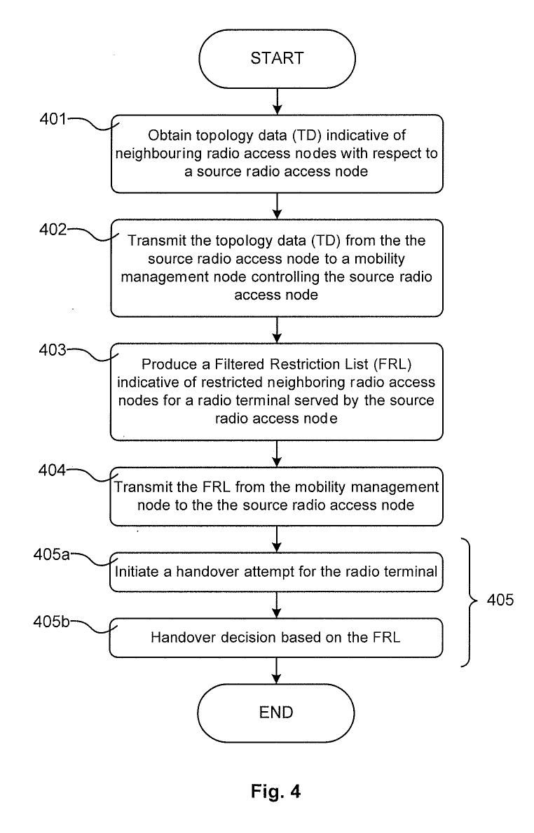

FIG. 4 is a flowchart illustrating a method according to an embodiment of the present solution. It is preferred that the method is performed in the radio access node 316a and/or in the mobility management node 310 of the system 300 shown in FIG. 3.

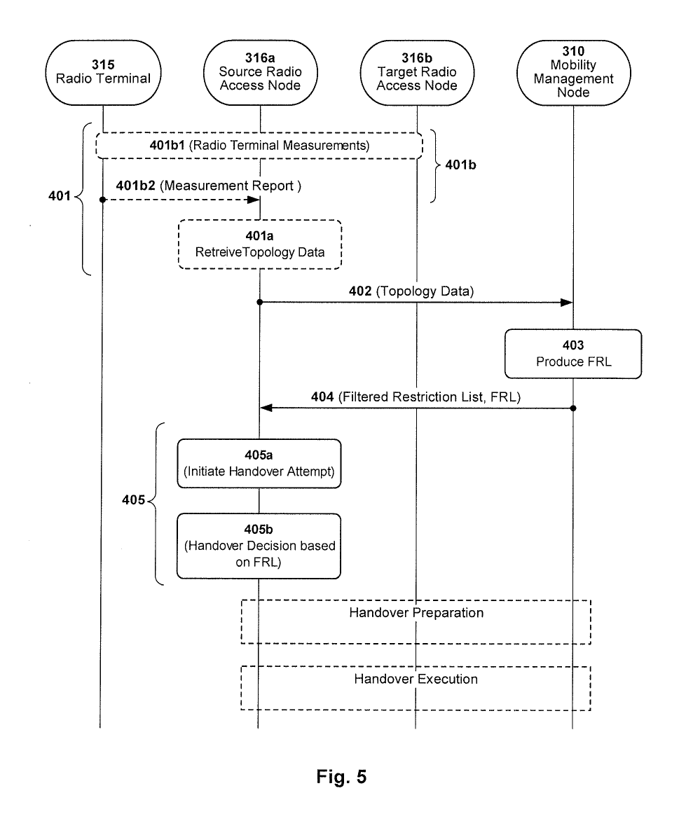

FIG. 5 is a sequence diagram illustrating an embodiment of the method in FIG. 4.

In a first action 401 of the exemplifying method illustrated in FIGS. 4 and 5 it is preferred that Topology Data (TD) indicative of one or more neighboring radio access nodes 316b and 316c is obtained. This may e.g. be performed by a topology obtaining procedure or similar, e.g. preformed in the source radio access node 316a, or in the radio terminal 315, or partly in the radio terminal 315 and partly in the source radio access node 316a as will be further described later.

The Topology Data (TD) may e.g. comprise information indicating the identity or similar of neighboring radio access nodes 316b and 316c. The identity of a neighboring radio access node may e.g. be provided by information indicating the cell identity and/or the node identity or similar of the neighboring radio access nodes, and/or indicating one or more group(s) or similar of radio access nodes to which neighboring radio access node(s) belong. A group of radio access nodes may e.g. be indicated by one or more Public Land Mobile Networks (PLMN) or similar, or by one or more Tracking Areas (TA) or similar and/or by one or more Location Areas (LA) or similar or by some other geographical area(s).

A neighboring radio access node may e.g. be one or more radio access nodes that are close to the source radio access node 316a and/or close to the radio terminal 315 served by the source radio access node 316a. A neighboring radio access node may e.g. be close in terms of short geographical distance (e.g. expressed in meters) with respect to the source radio access node 316a and/or in terms of high signal strength (e.g. expressed in dBW) and/or high signal quality (e.g. expressed as a SNR) or similar of the signals received by the radio terminal 315 and/or the source radio access node 316a from other radio access nodes. A neighboring radio access node may e.g. be a radio access node that is spatially adjacent to the source radio access node 316a, and/or a radio access node that has one or more cells that are adjacent to or included by one or more cells of the source radio access node. Two radio access nodes or two cells may e.g. be adjacent to each other when there is no other radio access node or cell between the two radio access nodes. Similarly, two cells may e.g., be adjacent to each other when there is no other cell between the two cells. It should be noted that the source radio access node 316a may have a first set of neighboring radio access nodes and the radio terminal 315 served by the source radio access node 316a may have a second set of neighboring radio access nodes. Both the first set and the second set comprise neighboring radio access nodes with respect to the source radio access node 316a. This follows from the fact that the radio terminal 315 served by the source radio access node 316a is close to the source radio access node 316a. Thus, a radio access node that is close to the radio terminal 315 is also close to the source radio access node 316a. The first set and the second set may be identical, or they may only have some radio access nodes in common. This may e.g. be due to the fact that the source radio access node 316a and the radio terminal 315 usually have different geographical locations such that they receive signals from various nearby radio access nodes differently. The source radio access node 316a and the radio terminal 315 may e.g. receive a signal from a nearby radio access node with different signal quality or different signal strength due to different reception conditions and/or due to permanent or temporal radio shadow or similar.

A sub-procedure 401a of the topology obtaining procedure 401 may be performed by the source radio access node 316a obtaining or retrieving at least a part of the topology data TD indicating at least one radio access node 316b and 316c as neighboring to the source radio access node 316a. To this end, the source radio access node 316a may use one or several communication interfaces 360 that connect the source radio access node 316a to one or several neighboring radio access nodes 316b and 316c. Preferably, each communication interface 360 connects the source radio access node 316a to at least one neighbouring radio access node 316b and 316c. Preferably, the communication interfaces 360 only connect the source radio access node 316a to neighboring radio access nodes, i.e. not to any other more distant radio access nodes. The source radio access node 316a may utilize the access node interface 360 to determine the presence of neighboring radio access nodes 316b and 316c, and preferably also their properties etc. This may e.g. be accomplished by predefining in the source radio access node 316a that the presence of communication or similar via an access interface 360, connecting the source radio access node 316a to another radio access, indicates that the other radio access node is a neighboring radio access node. In addition or alternatively, this may e.g. be accomplished by sending inquiries over the access interface 360 to investigate if any neighboring radio access node 316b and 316c responds and/or by requesting necessary information from the radio access nodes 316b and 316c connected to the source radio access node 316a via said interfaces 360, e.g. utilizing a predefined and shared communication protocol. A skilled person having the benefit of this disclosure realizes that the communication interfaces 360 now discussed may be any suitable interface that can be used by two or more radio access nodes to exchange information between each other. The communication interface may e.g. be a X2 interface as defined in the 3GPP specifications or similar.

An additional or alternative embodiment of the sub-procedure 401a may be performed by the source radio access node 316a obtaining at least a part of the topology data TD by accessing topology data TD that is pre-stored in the source radio access node 316a itself. The topology data TD may e.g. be pre-stored at the installation and/or manufacturing of the source radio access node 316a. Alternatively, the topology data TD may e.g. be pre-stored in the source radio access node 316a in that the source radio access node 316a receives the topology data TD from the core network 340 of the system 300. However, using pre-stored topology data TD is static and less favorable, since it typically requires that an operator enters data indicative of the neighboring radio access nodes, e.g. enters the data in the source radio access node 316a or similar, with the effect that updates required in response to changes in the topology may be delayed or even missing.

Another sub-procedure 401b of the topology obtaining procedure 401a may be performed by the source radio access node 316a receiving at least a part of the topology data TD from the radio terminal 315. As mentioned above, the source radio access node 316a may have a first set of neighboring radio access nodes and the radio terminal 315 served by the source radio access node 316a may have a second set of neighboring radio access nodes. Both sets are considered to comprise neighboring radio access nodes with respect to the source radio access node 316a.

The radio terminal 315 may e.g. obtain topology data TD by a terminal measurement 401b1 procedure or similar. The terminal 315 may e.g. measure the strength and/or quality or similar of signals received from a number of radio access nodes. The signals received from the radio access nodes may e.g. comprise information indicative of the topology data TD mentioned above, e.g. information indicating a cell identity and/or the node identity or similar of the transmitting radio access node, and/or the Tracking Area(s) (TA) or similar and/or Location Area(s) (LA) or similar to which the transmitting radio access nodes in question belongs. It is preferred that the radio terminal 315 is configured to obtain such topology data TD from the signals received from the radio access nodes.

Measurements of the power and/or quality or similar of signals received from a number of radio access nodes are regularly performed in most cellular systems, e.g. to enable handover of a radio terminal between various radio access nodes of the system. Similarly, the radio terminal 315 may in a known manner be configured to measure the signal power and/or quality or similar from a first number of radio access nodes and determine that a smaller second number of these radio access nodes with the highest signal power and/or signal quality or similar are neighboring radio access nodes 316b and 316c and that the other radio access nodes are distant radio access nodes.

The topology data TD of the neighboring radio access nodes obtained by the radio terminal 315 may be provided by the radio terminal 315 to the source radio access node 316a in a terminal measurement report transmission 401b2. The topology data TD may e.g. be transmitted by the radio terminal 315 and received by the source radio access node 316a, e.g. in a message, e.g. structured as and/or comprised by one or more data packets or similar.

As indicated above, the topology obtaining procedure 401 may be preformed in the source radio access node 316a, or in the radio terminal 315, or partly in the source radio access node 316a and partly in the radio terminal 315. Thus, only the first sub-procedure 401a of the topology obtaining procedure 401 may be performed, or only the second sub-procedure 401b may be performed. Alternatively, both the first sub-procedure 410a and the second sub-procedure 401b may be performed, e.g. so as to assure that the neighboring radio access nodes obtained by the first sub-procedure 401a and the neighboring radio access nodes obtained by the second sub-procedure 401b are included in the final list or selection or similar of neighboring radio access nodes to be provided as topology data TD to the mobility management node 310 in the second action 402, as will be described in more detail later.

Note that the topology obtaining procedure 401 or parts thereof may be performed well in advance of providing the topology data TD to the mobility management node 310. For example, the source radio access node 316a may at any time obtain the topology data TD or a part thereof by using one or several access node interfaces 360 or similar that connect the source radio access node 316a to one or several neighboring radio access nodes, e.g. as indicated above. Likewise, the source radio access node 316a may at any time receive the topology data TD or a part thereof from one or more radio terminals 315 that are currently served or have previously been served by the source radio access node 316a. The source radio access node 316a may in this manner obtain the topology data TD from different resources at different occasions. This applies mutatis mutandis to the other embodiments described herein.

In a second action 402 of the exemplifying method illustrated in FIGS. 4 and 5 it is preferred that information indicative of the topology data TD obtained in the first action 401 is provided by the source radio access node 316a to the network mobility management node 310. The information indicative of the topology data TD may be transmitted by the source node 316a and received by the network mobility management node 310, e.g. transmitted in a topology data message or similar, e.g. structured as and/or comprised by one or more data packets or similar.

The structure of an exemplifying Information Entity (1E) comprising topology data TD is given in Table A below.

TABLE A
An exemplifying Information Entity (IE) comprising topology data

| IE/Group | | | IE type and | Semantics |
|---|---|---|---|---|
| Name | Presence | Range | reference | description |
| Possible TAs | | 0 . . . <maxnoofPLMNs> | | |
| >PLMN Identity | M | | 9.2.3.8 | The PLMN of possible |
| | | | | TACs |
| >Possible TACs | | 1 . . . <maxnoofForbTACs> | | |
| >>TAC | M | | 9.2.3.7 | The TAC of the possible |
| | | | | TAI |
| Possible LAs | | 0 . . . <maxnoofPLMNs> | | |
| >PLMN Identity | M | | 9.2.3.8 | |
| >Possible LACs | | 1 . . . <maxnoofForbLACs> | | |
| >>LAC | M | | OCTET | |
| | | | STRING(2) | |

In a third action 403 of the exemplifying method illustrated in FIGS. 4 and 5 it is preferred that a filtered restriction list (FRL) is produced by the network mobility management node 310 based on the topology data TD received from the source radio access node 316a in the second action 402. To this end it is preferred the network mobility management node 310 comprises and/or has access to Terminal Restriction Data (TRD) indicating the radio access node or nodes that are restricted for the radio terminal 315 served by the source radio access node 316a. The terminal restriction data TRD may e.g. be preconfigured in the network mobility management node 310 and/or be received and/or retrieved by the network mobility management node 310 from the home subscriber Server 317 of the wireless communication system 300 in FIG. 3 and/or from any other suitable node in the core network 340 of the system 300. A radio access node may be restricted for the radio terminal 315 such that the radio terminal 315 can and/or will not be served by the radio access node, e.g. such that the radio terminal 315 is not allowed to be handed over to the restricted radio access node. This may e.g. be determined by the operator of the wireless communication system 300 in FIG. 3.

It is preferred that the Terminal Restriction Data (TRD) indicates all the radio access nodes that are restricted for the radio terminal 315 in the wireless communication system 300. However, in some embodiments it may be sufficient if the terminal restriction data TRD indicates a subset of all the radio access nodes that are restricted for the radio terminal 315, provided that the subset at least indicates the neighboring radio access nodes that are restricted for the radio terminal 315. It is preferred that the terminal restriction data TRD indicates the restricted radio access node or nodes in the same or similar manner as the topology data TD, thus enabling the network mobility management node 310 to match neighboring radio access nodes indicated by the topology data TD and restricted radio access nodes indicated by the restriction information. Thus, the terminal restriction data TRD may comprise information indicating the cell identity and/or a node identity or similar of restricted radio access nodes, and/or one or more group(s) or similar of restricted radio access nodes, e.g. represented by one or more Tracking Area(s) (TA) or similar and/or by one or more Location Area(s) (LA) or similar or some other geographical area(s).

As indicated above, it is preferred that the filtered restriction list FRL is produced by the network mobility management node 310 based on the topology data TD received from the source radio access node 316a. The filtered restriction list FRL may e.g. be produced by matching the received topology data TD and the terminal restriction data TRD, e.g. such that a neighboring radio access node is added to the filtered restriction list FRL when the neighboring access nodes is indicated by both the topology data TD and the terminal restriction data TRD.

The resulting Filtered Restriction List (FRL) comprises information indicative of one or several restricted neighboring radio access nodes for a radio terminal currently served by the source radio access node. In the exemplifying system 300 shown in FIG. 3 it is assumed that the radio terminal 315 is currently served by the source radio access node 316a and that the FRL for the radio terminal 315 would comprise information indicating the restricted neighboring radio access node 316c. The restricted neighboring radio access nodes may e.g. be indicated by information identifying the restricted neighboring radio access nodes or the inverse thereof, i.e. by information identifying the allowed neighboring radio access nodes. It should be emphasized that the FRL comprises information indicating the neighboring radio access nodes that are restricted for the radio terminal 315, not other more distant radio access nodes that may also be restricted for the terminal 315. Thus, the amount of data transmitted in a filtered restriction list FRL is dramatically reduced, e.g. compared to a handover restriction list HRL that comprises information indicating all the radio access nodes in the system 300 that are restricted for the radio terminal 315.

An exemplifying Information Entity (IE) comprising a filtered restriction list FRL is given in Table 6 below. The structure may be the same or similar as in the IE given in the specification 3GPP TS 36.413 v10.0 (2011-03) paragraph 9.2.1.22 illustrated by the figure therein. However, the size and content of the filtered restriction list FRL discussed herein is dramatically smaller than an ordinary unfiltered handover restriction list (HRL).

TABLE B
An exemplifying Information Entity (IE) comprising a Filtered Restriction List FRL

| IE/Group | | | IE type and | Semantics |
|---|---|---|---|---|
| Name | Presence | Range | reference | description |
| Serving | M | | 9.2.3.8 | |
| PLMN | | | | |
| Equivalent | | 0 . . . <maxnoofEPLMNs> | | Allowed PLMNs in |
| PLMNs | | | | addition to |
| | | | | Serving PLMN. |
| | | | | This list |
| | | | | corresponds |
| | | | | to the list of |
| | | | | “equivalent |
| | | | | PLMNs” as |
| | | | | defined in |
| | | | | [TS 24.008]. |
| >PLMN | M | | 9.2.3.8 | |
| Identity | | | | |
| Forbidden | | 0 . . . <maxnoofEPLMNsPlusOne> | | intra LTE roaming |
| TAs | | | | restrictions |
| >PLMN | M | | 9.2.3.8 | The PLMN of |
| Identity | | | | forbidden TACs |
| >Forbidden | | 1 . . . <maxnoofForbTACs> | | |
| TACs | | | | |
| >>TAC | M | | 9.2.3.7 | The TAC of the |
| | | | | forbidden TAI |
| Forbidden | | 0 . . . <maxnoofEPLMNsPlusOne> | | inter-3GPP |
| LAs | | | | RAT roaming |
| | | | | restrictions |
| >PLMN | M | | 9.2.3.8 | |
| Identity | | | | |
| >Forbidden | | 1 . . . <maxnoofForbLACs> | | |
| LACs | | | | |
| >>LAC | M | | OCTET STRING(2) | |
| Forbidden | O | | ENUMERATED(ALL, | inter-3GPP |
| inter RATs | | | GERAN, UTRAN, | and 3GPP2 |
| | | | CDMA2000, . . . , | RAT access |
| | | | GERAN and | restrictions |
| | | | UTRAN, CDMA2000 | |
| | | | and UTRAN) | |

In Table B it can be seen that the allowed PLMNs is defined through the “Serving PLMN” and “Equivalent PLMNs” IEs. While forbidden Tracking Areas (TAs) and forbidden Location Areas (LAs) within these PLMNs are defined by use of the “Forbidden TAs” IE and the “Forbidden LAs” IE respectively.

As already indicated above, the exemplifying actions 401, 402 and 403 have been described with references to the exemplifying system 300 in FIG. 3a under the assumption that the system 300 comprises the source radio access node 316a currently serving the radio terminal 315, and that the source radio access node 316a has three neighboring radio access nodes, namely a target radio access node 316b, a restricted radio access node 316c and an originating radio access node 316d from which the radio terminal 315 may have been previously handed over to the source radio access node 316a. Possible handover actions have been indicated with dashed lines in FIG. 3. The dashed line from the source radio access node 316a to the restricted radio access node 316c does not reach the restricted radio access node 316c. This illustrates that a handover of the radio terminal 315 from the source radio access node 316a to the restricted radio access node 316c will be aborted, as will be described in more detail below.

In a fourth action 404 of the exemplifying method illustrated in FIGS. 4 and 5 it is preferred that the filtered restricted list FRL produced in the third action 403 is provided by the network mobility management node 310 to the source radio access node 316a. The filtered restricted list FRL may be transmitted by the network mobility management node 310 and received by the source radio access node 316a, e.g. in a message or similar, e.g. structured as and/or comprised by one or more data packets or similar.

In a fifth action 405 of the exemplifying method illustrated in FIGS. 4 and 5 it is preferred that the source radio access node 316a makes a handover decision as a response to an initiated handover attempt to a target radio access node, such that the attempt is aborted when the target radio access node is indicated in the filtered restriction list FRL and approved for further processing when the target radio access node is not indicated in the filtered restriction list FRL. The handover decision may be done at any time once the filtered restriction list FRL has been received in action 404. The handover decision 405 is preferably done independent of the other actions 401, 402, 403 and 404 described above.

The handover attempt may be initiated in a sub-action 405a of the fifth action 405. The initiated handover attempt may include one or several neighboring radio access nodes as candidate target radio access nodes. For example, as indicated above when discussing the terminal measurement 401b1, the radio terminal 315 may measure the signal power and/or quality or similar from a first number of radio access nodes and determine that a smaller second number of these radio access nodes with the highest signal power and/or quality or similar are neighboring radio access nodes with the effect that only these neighboring radio access nodes will be candidate target radio access nodes.

The handover decision may be executed in another sub-action 405b of the fifth action 405. The handover decision may comprise a plurality of handover abortions, e.g. one abortion for each restricted candidate target radio access node until a suitable target radio access node is approved. As already indicated, a candidate target radio access node may be approved if the candidate target radio access node is not indicated in the FRL. If all candidate target radio access nodes are indicated in the FRL then the handover attempt may be aborted in full and the radio terminal 315 currently served by the source radio access node 316a may stay served by the source radio access node 316a or the radio terminal 315 may simply loose access to resources provided by the system 300. Before proceeding it should be noted that a handover attempt may be aborted even if one or more candidate target radio access node are not indicated in the FRL, thus as such enabling an approval of the handover attempt. There may be other reasons for aborting a handover.

In FIG. 3a it assumed that the neighboring radio access node 316b is a candidate target radio access node that is not indicated in the FRL, and that the neighboring radio access node 316c is a candidate target radio access node that is indicated in the FRL. It is also assumed that a handover attempt to the candidate neighboring radio access node 316b is approved by the source radio access node 316a, whereas a handover attempt to the restricted candidate neighboring radio access node 316c is aborted by the source radio access node 316a. The handover attempt is aborted even if the signal strength or signal quality from the restricted candidate neighboring radio access node 316c is the highest among the signals received from the neighboring radio access nodes. When a handover attempt is approved by the source radio access node 316a then a handover preparation or similar may be initiated by the source radio access node 316a as indicated in FIG. 5.

The handover preparation has been enclosed by dashed lines in FIG. 5 to indicate that there may be no handover preparation, e.g. if the handover attempt is aborted by the source radio access node 316a due, as may be the case when all candidate target radio access nodes are indicated in the FRL. A handover attempt may also be aborted even if no neighboring radio access nodes are indicated in the FRL, since there may be other reasons for aborting a handover attempt.

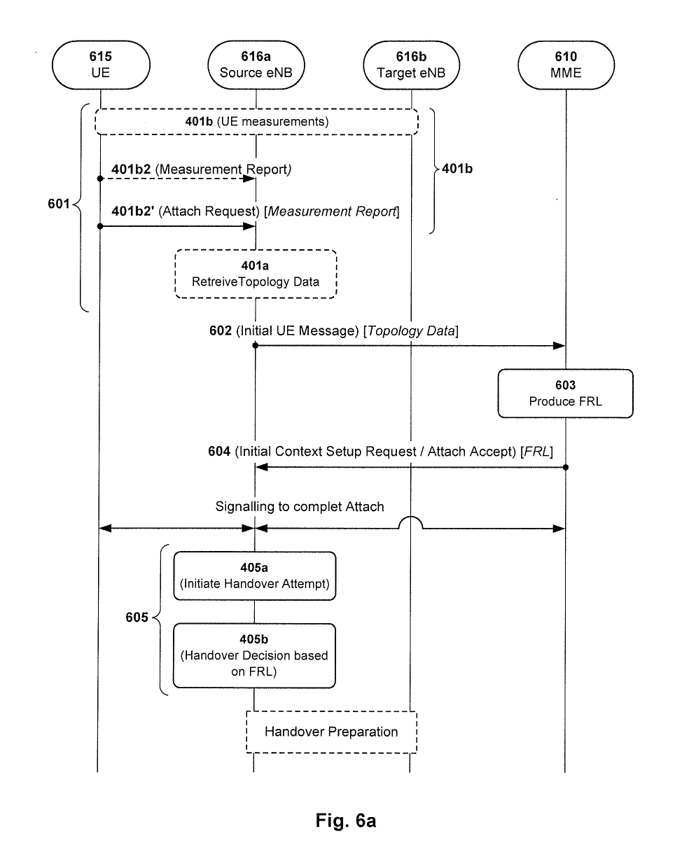

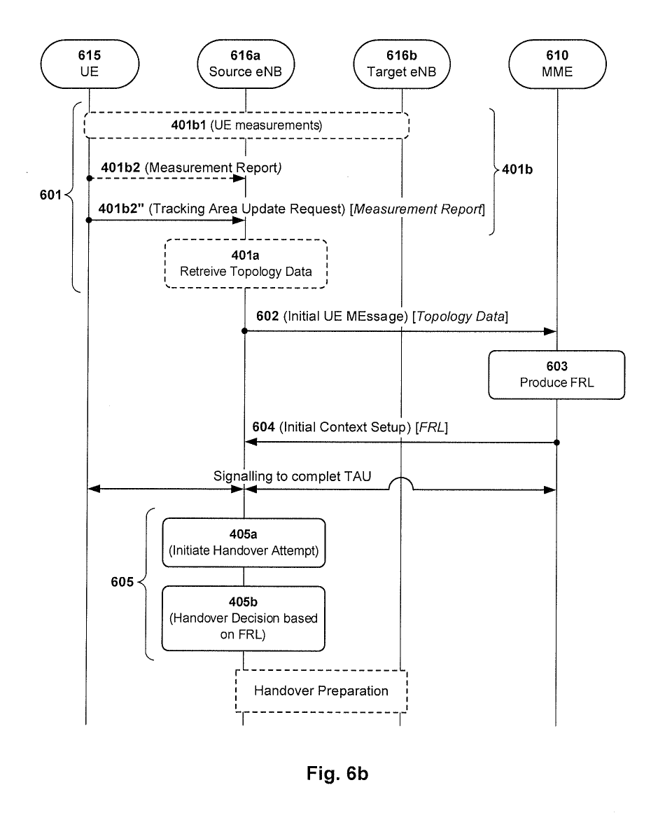

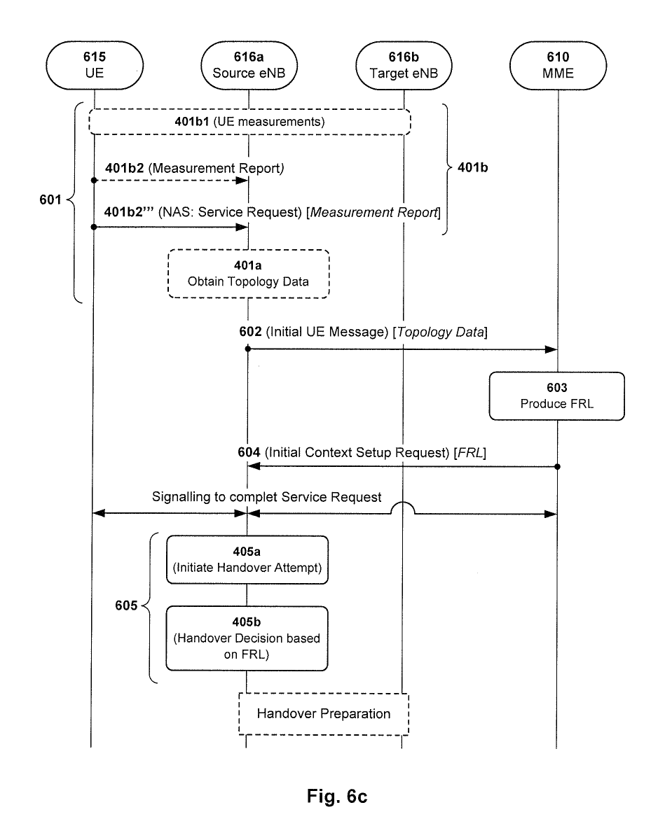

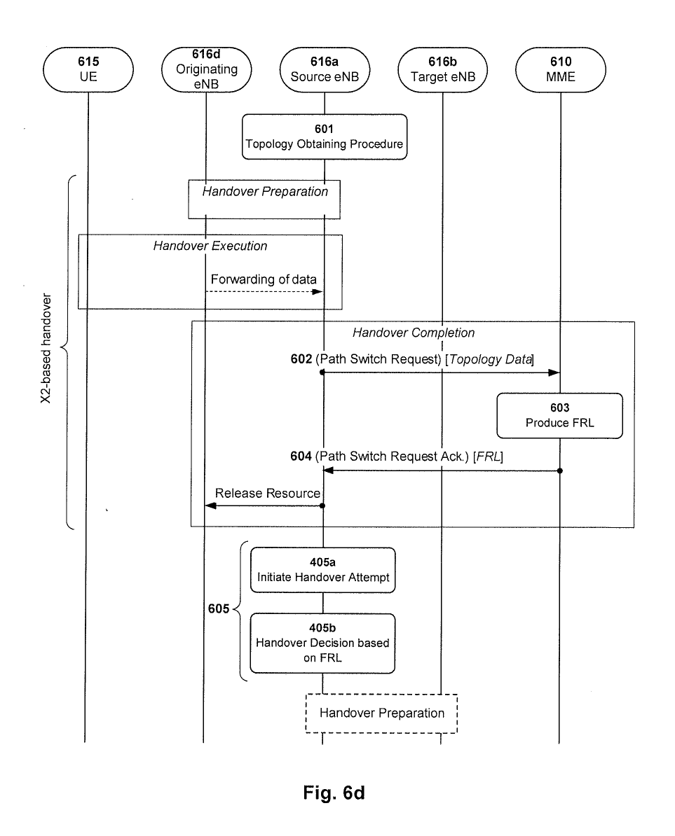

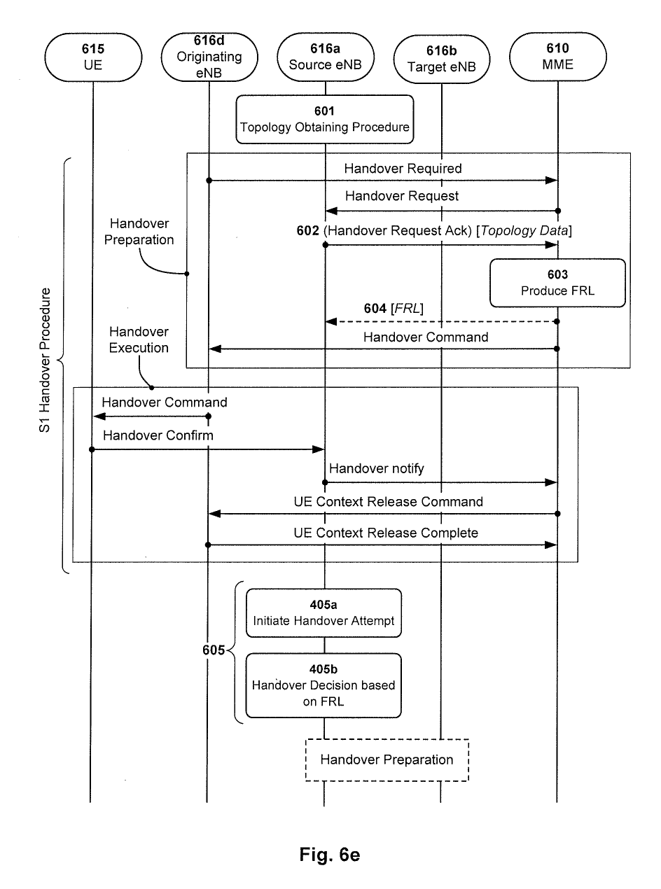

The attention is now directed to FIGS. 6a, 6b, 6c, 6d and 6e that illustrate more specific manners of performing the exemplifying method discussed above with reference to FIGS. 3, 4 and 5. In FIGS. 6a, 6b, 6c, 6d and 6e it is assumed that the mobility management node is a Mobility Management Entity (MME) 610 or similar and that the radio terminal is a User Equipment (UE) 615 or similar and that the source radio access node is a source Evolved NodeB (eNB) 616a or similar and that the target radio access node is also a target eNB 616b or similar and that the access node interface is an X2-interface or similar and that the network node interface is a S1-interface or similar and that the air interface is an Uu-interface or similar, all according to the 3GPP specifications. However, it should be emphasized that the solution disclosed herein is not in any way limited to UE:s, eNB:s, MME:s, X2-interfaces, S1-interfaces or Uu-interfaces or similar as defined in the 3GPP specifications. On the contrary, the solution may be implemented in any suitable system comprising corresponding terminals and nodes.

FIG. 6a shows a signaling diagram illustrating the exemplifying method discussed above with reference to FIGS. 4 and 5, now executed in connection with an attachment procedure. The signaling diagram in FIG. 6a illustrates how the UE 615 attaches to the network (e.g. such as the 3GPP Evolved Packet Core (EPC) being similar to the core network 340 in FIG. 3) by leaving an idle state and entering a connected state with respect to the source eNB 616a. An attach request is typically required to enable the UE 615 to eventually access the resources provided by the network. The UE 615 may be regarded as served by the source eNB 616a already when it attaches to the source eNB 616a. Various attach procedures are well known to those skilled in the art. A known attach procedure is e.g. described in the specification 3GPP TS 23.401 v10.4.0 (2011-06) at paragraph 5.3.2, see e.g. FIG. 5.3.2.1-1 therein.

Generally, a radio terminal has entered a connected state with respect to the source radio access node in the sense described in the 3GPP specifications, and/or radio terminal has entered a connected state with respect to the source radio access node when the source radio access node controls the mobility of the radio terminal, e.g. such that the source radio access node will make the handover decision for the radio terminal in case a handover is required.

As can be seen in FIG. 6a a first action 601, which executes a topology obtaining procedure, is preferably the same as the first action 401 previously described with reference to FIGS. 4 and 5. However, another measurement report transmission 401b2′ has been added in FIG. 6a. The other measurement report transmission 401b2′ comprises an Attach Request message or similar transmitted by the UE 615 and received by the source eNB 616a in connection with the attach procedure, e.g. in a similar manner as in the 3GPP specification mentioned above, see e.g. FIG. 5.3.2.1-1 therein. The Attach Request message may comprise information indicating the topology data TD obtained by the UE 615. The measurement report transmission 401b2 previously discussed and the other measurement report transmission 401b2′ now discussed offer alternative or complementary ways of providing the source eNB 616a with topology data TD from the UE 615. Note that the source eNB 616 may at any time receive topology data TD or a part thereof in a measurement report transmission 401b2 sent from one or more UEs that are currently served or have previously been served by the source eNB 616a. This is preferably done independent of the attach procedure.

The second action 602 in FIG. 6a, providing information indicative of the topology data TD from the source eNB 616a to the MME 610, is preferably the same as the action 402 described above with reference to FIGS. 4 and 5. However, the second action 602 has been specified in FIG. 6a such that the information indicative of the TD is transmitted by the source eNB 616a and received by the MME 610 by an Initial UE Message or similar, e.g. in a similar manner as in the 3GPP specification mentioned above, see e.g. FIG. 5.3.2.1-1 therein. The Initial UE Message may be seen as a forwarding of the attach request received from the UE 615 in the first action 601. Note that the Initial UE Message has been modified so as to comprise information indicating the topology data TD.

The third action 603 in FIG. 6a is preferably the same as the third action 403 described above with reference to FIGS. 4 and 5, however now executed in an MME 610.

The fourth action 604 in FIG. 6a, providing the filtered restriction list FRL from the MME 610 to the source eNB 616a, is preferably the same as the fourth action 404 described above with reference to FIGS. 4 and 5. However, the fourth action 604 has been specified in FIG. 6a such that the filtered restriction list FRL is transmitted by the MME 610 and received by the source eNB 616a in an Initial Context Setup Request/Attach Accept message, e.g. in a similar manner as in the 3GPP specification mentioned above; see e.g. FIG. 5.3.2.1-1 therein. It can be noted that an Initial Context Setup Request/Attach Accept message according to the 3GPP specifications may comprise an unfiltered handover restriction list (HRL).

The fifth action 605 in FIG. 6a, providing a handover decision based on the filtered restriction list FRL received in step 604, is preferably the same as the fifth action 405 described above with reference to FIGS. 4 and 5, however now executed in a source eNB 616a. The handover decision may be done at any time once the filtered restriction list FRL has been received. The handover decision is preferably done independent of the attach procedure.

A handover preparation or similar may be performed in the same or similar manner as described above with reference to FIGS. 4 and 5.

FIG. 6b shows a signaling diagram illustrating the exemplifying method discussed above with reference to FIGS. 4 and 5, now executed in connection with a tracking area updating (TAU) procedure. The signaling diagram in FIG. 6b illustrates how the tracking area TA is updated for the UE 615. A tracking area update may e.g. be required when the UE 615 detects that it is in a new tracking area. The UE 615 may be regarded as served by the source eNB 616a when the tracking area is updated. Various tracking area update procedures are well known to those skilled in the art. A known tracking area update procedure is e.g. described in the specification 3GPP TS 23.401 v10.4.0 (2011-06) at paragraph 5.3.3, see e.g. FIG. 5.3.3.1-1 therein. Note that that the Tracking Area and Tracking Area Update correspond to a Routing Area (RA) and a Routing Area Update (RAU) respectively for packet switched in GSM and WCDMA and EDGE and GPRS and HSPA. Similarly, the Tracking Area and Tracking Area Update correspond to a Location Area (LA) and a Location Area Update (LAU) respectively for packet switched in GSM and WCDMA.

As can be seen in FIG. 6b the first action 601, which executes a topology obtaining procedure, is preferably the same as the first action 401 previously described with reference to FIGS. 4 and 5. However, another measurement report transmission 401b2″ has been added in FIG. 6b. The other measurement report transmission 401b2″ comprises a Tracking Area Update Request message or similar transmitted by the UE 615 and received by the source eNB 616a in connection with the tracking area updating procedure, e.g. in a similar manner as in the 3GPP specification mentioned above; see e.g. FIG. 5.3.2.1-1 therein. The Tracking Area Update Request message may comprise information indicating the topology data TD obtained by the UE 615. The measurement report transmission 401b2 previously described and the other measurement report transmission 401b2″ now discussed offer alternative or complementary ways of providing the source eNB 616a with topology data from the UE 615. Note that the source eNB 616 may at any time receive topology data TD or a part thereof in a measurement report transmission 401b2 sent from one or more UEs that are currently served or have previously been served by the source eNB 616a. This is preferably done independent of the tracking area update procedure.

The second action 602 in FIG. 6b, providing information indicative of the topology data TD from the source eNB 616a to the MME 610, is preferably the same as the action 402 described above with reference to FIGS. 4 and 5. However, the second action 602 has been specified in FIG. 6b such that the information indicative of the topology data TD is transmitted by the source eNB 616a and received by the MME 610 in an Initial UE Message or similar, e.g. in a similar manner as in the 3GPP specification mentioned above; see e.g. FIG. 5.3.3.1-1 therein. Note that the Initial UE Message has been modified so as to comprise information indicating the topology data TD.

The third action 603 in FIG. 6b is preferably the same as the third action 403 described above with reference to FIGS. 4 and 5, however now executed in a MME 610.

The fourth action 604 in FIG. 6b, providing the filtered restriction list FRL from the MME 610 to the source eNB 616a, is preferably the same as the fourth action 404 described above with reference to FIGS. 4 and 5. However, the fourth action 604 has been specified in FIG. 6b such that the filtered restriction list FRL is transmitted by the by the MME 610 and received by the source eNB 616a in an Initial Context Setup message, e.g. in a Tracking Area Update Accept message or similar, e.g. in a similar manner as in the 3GPP specification mentioned above, see e.g. FIG. 5.3.3.1-1 therein. It can be noted that a Tracking Area Update Accept message according to the 3GPP specifications may comprise an unfiltered handover restriction list (HRL).

The fifth action 605 in FIG. 6b, providing a handover decision based on the filtered restriction list FRL received in step 404, is preferably the same as the fifth action 605 described above with reference to FIGS. 4 and 5, however now executed in a source eNB 616a. The handover decision may be done at any time once the filtered restriction list FRL has been received. The handover decision is preferably done independent of the tracking area update procedure.

A handover preparation or similar may be performed in the same or similar manner as described above with reference to FIGS. 4 and 5.

FIG. 6c shows a signaling diagram illustrating the exemplifying method discussed above with reference to FIGS. 4 and 5, now executed in connection with a service request procedure. The signaling diagram in FIG. 6c illustrates how a service request is handled for the UE 615. A service request may e.g. be required to enable the UE 615 to utilize the services provided by the network (e.g. such as the core network 340 in FIG. 3). A service request procedure may e.g. be initiated when the network has downlink signaling pending, or the UE 615 has uplink signaling pending or the UE 615 or the network has user data pending. Various service request procedures are well known as such to those skilled in the art. A known service request procedure is e.g. described in the specification 3GPP TS 23.401 v10.4.0 (2011-06) at paragraph 5.3.4, see e.g. FIG. 5.3.4.1-1 therein.

As can be seen in FIG. 6c the first action 601, which executes a topology obtaining procedure, is preferably the same as the first action 401 previously described with reference to FIGS. 4 and 5. However, another measurement report transmission 401b2′″ has been added in FIG. 6c. The other measurement report transmission 401b2′″ comprises a NAS: Service Request message or similar transmitted by the UE 615 and received by the source eNB 616a in connection with the service request procedure, e.g. in a similar manner as in the 3GPP specification mentioned above; see e.g. FIG. 5.3.4.1-1 therein. The NAS: Service Request message may comprise information indicating the topology data TD obtained by the UE 615. The measurement report transmission 401b2 previously described and the other measurement report transmission 401b2″″ now discussed offer alternative or complementary ways of providing the source eNB 616a with topology data from the UE 615. Note that the source eNB 616 may at any time receive topology data TD or a part thereof in a measurement report 401b2 sent from one or more UEs that are currently served or have previously been served by the source eNB 616a. This is preferably done independent of the service request procedure.

The second action 602 in FIG. 6c, providing information indicative of the topology data TD from the source eNB 616a to the MME 610, is preferably the same as the second action 402 described above with reference to FIGS. 4 and 5. However, the second action 602 has been specified in FIG. 6c such that that information indicative of the TD is transmitted by the source eNB 616a and received by the MME 610 in an Initial UE Message message, e.g. in a similar manner as in the 3GPP specification mentioned above, see e.g., FIG. 5.3.4.1-1 therein. Note that the Initial UE Message has been modified so as to comprise information indicating the topology data TD.

The third action 603 in FIG. 6c is preferably the same as the third action 403 described above with reference to FIGS. 4 and 5, however now executed in a MME 610.

The fourth action 604 in FIG. 6c, providing the filtered restriction list FRL from the MME 610 to the source eNB 616a, is preferably the same as the fourth action 404 described above with reference to FIGS. 4 and 5. However, the fourth action 604 has been specified in FIG. 6c such that the filtered restriction list FRL is transmitted by the MME 610 and received by the source eNB 616a in an Initial Context Setup Request message, e.g. in a similar manner as in the 3GPP specification mentioned above, see e.g. FIG. 5.3.4.1-1 therein. It can be noted that the Initial Context Setup Request message according to the 3GPP specifications may comprise an unfiltered handover restriction list (HRL).

The fifth action 605 in FIG. 6c, providing a handover decision based on the filtered restriction list FRL received in step 404, is preferably the same as the fifth action 405 described above with reference to FIGS. 4 and 5, however now executed in a source eNB 616a. The handover decision may be done at any time once the filtered restriction list FRL has been received by the source eNB 6161a. The handover decision is preferably done independent of the service request procedure.

A handover preparation may be performed in the same or similar manner as described above with reference to FIGS. 4 and 5.

FIG. 6d shows a signaling diagram schematically illustrating the exemplifying method discussed above with reference to FIGS. 4 and 5, now executed in connection with a handover procedure. The signaling diagram in FIG. 6d illustrates how the UE 615 is originally handed over from an originating eNB 616d to the source eNB 616a and then to the target eNB 616b. The handover to from source eNB 616a to the target eNB 616b may occur at any time after the handover from the originating eNB 616d to the source eNB 616a. The handover to from source eNB 616a to the target eNB 616b is preferably done independent from the handover from the originating eNB 616d. A handover of the UE 615 may e.g. be required when the UE 615 is within reach of an eNB that provides more favorable signaling conditions compared to the eNB currently serving the UE 615. The UE 615 may be regarded as served by the source eNB 616a after a handover from the originating eNB 616d. Various handover procedures are well known to those skilled in the art and the handover procedure in FIG. 6d needs no detailed description as such. A known handover procedure of the same or similar kind as the one illustrated in FIG. 6d is e.g. disclosed as an X2-based handover in the specification 3GPP TS 23.401 v10.4.0 (2011-06) at paragraph 5.5.1.1, see e.g. FIG. 5.5.1.1.2-1 therein; or in the specification 3GPP TS 36.300 v10.4.0 (2011-06) at paragraph 10.1.2.1.1, see e.g. FIG. 10.12.1.1-1 therein.

As can be seen in FIG. 6d the first action 601, which executes a topology obtaining procedure, is preferably the same as the first action 401 previously described with reference to FIGS. 4 and 5, or previously described with reference to any one of FIG. 6a, 6b or 6c.

Note that the topology obtaining procedure 601 or parts thereof may be performed well in advance of providing the topology data TD to the MME 610 in the second action 602, as will be further described below. For example, the source eNB 616a may at any time obtain the topology data TD or a part thereof by using one or several X2-interfaces or similar that connect the source eNB 616a to one or several neighboring eNBs, e.g. as indicated above when discussing the sub-procedure 401a with reference to FIG. 5. Likewise, the source eNB 616a may at any time receive the topology data TD or a part thereof from one or more UE:s that are currently served or have previously been served by the eNB 616a. The source eNB 616a may in this manner obtain the topology data TD from different resources at different occasions. This applies mutatis mutandis to the other embodiments described herein.

As can be seen in FIG. 6d it is assumed that the originating handover procedure is initiated before the Topology Data TD is provided by the source eNB 616a to the MME 610. It is also assumed that the originating handover procedure has been completed before a handover decision is made based on a filtered restriction list FRL in the fifth action 605 as will be further described below.

The second action 602 in FIG. 6d, providing information indicative of the topology data TD from the source eNB 616a to the MME 610, is preferably the same as the action 402 described above with reference to FIGS. 4 and 5. However, the second action 602 has been specified in FIG. 6d such that information indicative of the TD is transmitted by the source eNB 616a and received by the MME 610 in a Path Switch Request message or similar in connection with the handover procedure now described, e.g. in a similar manner as in the specification 3GPP TS 23.401 v10.4.0 (2011-06) at paragraph 5.5.1.1, see e.g. FIG. 5.5.1.1.2-1 therein. Note that the Path Switch Request message in the second action 602 has been modified so as to comprise information indicating the topology data TD. The transmitted topology data TD will be used by the MME 610 in the third action 603 briefly described next.

The third action 603 in FIG. 6d is preferably the same as the third action 403 described above with reference to FIGS. 4 and 5, however now executed in a MME 610.

The fourth action 604 in FIG. 6d, providing the filtered restriction list FRL from the MME 610 to the source eNB 616a, is preferably the same as the fourth action 404 described above with reference to FIGS. 4 and 5. However, the fourth action 604 has been specified in FIG. 6d such that the filtered restriction list FRL is transmitted by the by the MME 610 and received by the source eNB 616a in a Path Switch Request Acknowledge message, e.g. in a similar manner as in the 3GPP specification mentioned above, see e.g. FIG. 5.5.1.1.2-1 therein. Note that a Path Switch Request Acknowledge message according to the 3GPP specifications may comprise an unfiltered handover restriction list (HRL).

The source eNB 616a may then send a Release Resource message or a similar release message to the originating eNB 316d subsequent to the Path Switch Request Acknowledge message received by the source radio access node 616a in the fourth action 604. Moreover, as can be seen in FIG. 6d, actions 602, 603 and 604 may be part of a Handover Completion procedure or similar, i.e. a completion of the originating handover procedure mentioned above.

The fifth action 605 in FIG. 6d, providing a handover decision based on the filtered restriction list FRL received in step 604, is preferably the same as the fifth action 405 described above with reference to FIGS. 4 and 5, however now executed in a source eNB 616a. The handover decision may be done at any time once the filtered restriction list FRL has been received. The handover decision 605 is preferably done independent of the handover procedure described above.

If a handover attempt, intending to handover the UE 615 from the source eNB 616a to the target eNB 616b, is approved in the fifth action 605 then a handover preparation may be performed in the same or similar manner as described above with reference to FIGS. 4 and 5.

FIG. 6e shows a signaling diagram schematically illustrating the exemplifying method discussed above with reference to FIGS. 4 and 5, now executed in connection with another handover procedure. The signaling diagram in FIG. 6e illustrates how the UE 615 is originally handed over from an originating eNB 616d to the source eNB 616a and then to the target eNB 616b. The originating handover procedure illustrated in FIG. 6e corresponds to the handover procedure described above with reference to FIG. 6d, except that the signaling between the UE 615, the originating eNB 616d, the source eNB 616a, the target eNB 616b and the MME 610 differs from the one illustrated in FIG. 6d. As already stated above, various handover procedures are well known to those skilled in the art and the handover procedure in FIG. 6e needs no detailed description as such. A known handover procedure of the same or similar kind as the originating handover procedure illustrated in FIG. 6e is e.g. disclosed as an S1-based handover described in the specification 3GPP TS 23.401 v10.4.0 (2011-06) at paragraph 5.5.1.2, see e.g. FIG. 5.5.1.2.2-1 therein.

The first action 601 in FIG. 6e, which executes a topology obtaining procedure, is preferably the same as the first action 601 previously described with reference to FIG. 6d. Thus, it is assumed that the originating handover procedure is initiated before the Topology Data TD is provided by the source eNB 616a to the MME, and that the originating handover procedure has been completed before a handover decision is made based on a filtered restriction list FRL.

The originating eNB 616d may, to initiate the originating handover procedure, send a Handover Required message or a similar handover initiating message to the MME 610. The MME 610 may as a response to the initiating message send a Handover Request message received by the source radio access node 616a.

The second action 602 in FIG. 6e, providing information indicative of the topology data TD from the source eNB 616a to the MME 610, is preferably the same as the action 602 described above with reference to FIG. 6d. However, the second action 602 has been specified in FIG. 6e such that the information indicative of the topology data TD is transmitted by the source eNB 616a and received by the MME 610 in a Handover Request Acknowledge message or similar in connection with the handover procedure now described, e.g. in a similar manner as in the specification 3GPP TS 23.401 v10.4.0 (2011-06) at paragraph 5.5.1.1, see e.g. FIG. 5.5.1.2.2-1 therein. Note that the Handover Request Acknowledge message in the second action 602 has been modified so as to comprise information indicating the topology data TD. The transmitted topology data TD will be used by the MME 610 in the third action 603 briefly described next.

The third action 603 in FIG. 6e is preferably the same as the third action 603 described above with reference to FIG. 6e.

The fourth action 604 in FIG. 6e, providing the filtered restriction list FRL from the MME 610 to the source eNB 616a, is preferably the same as the fourth action 604 described above with reference to FIG. 6d. However, the fourth action 604 has been specified in FIG. 6d such that the filtered restriction list FRL is transmitted by the by the MME 610 and received by the source eNB 616a in a Filtered HRL message. This message may e.g. be a new message that has no present correspondence in the in the 3GPP specifications. The Filtered HRL message may e.g. comprise an Information Entity (IE) with a filtered restriction list FRL as indicated in Table B above.

The fifth action 605 in FIG. 6e, providing a handover decision based on the filtered restriction list FRL received in step 604, is preferably the same as the fifth action 605 described above with reference to FIG. 6d. The handover decision may be done at any time once the filtered restriction list FRL has been received by the source eNB 6161a. The handover decision 605 is preferably done independent of the handover procedure described above.

If a handover attempt, intending to handover the UE 615 from the source eNB 616a to the target eNB 616b, is approved in the fifth action 605 then a handover preparation or similar may be performed in the same or similar manner as described above with reference to FIG. 6d.

As already indicated above, some embodiments of the method indicated in FIG. 4 may have the topology obtaining procedure 401; 601 or parts thereof performed by the source radio access node well in advance of any other of the actions 402; 602, 403; 603 and 405; 605 of exemplifying embodiments described herein. Some embodiments may have the topology obtaining procedure 401; 601 or parts thereof performed in connection with or at the same time as the actions 402; 602, 403; 603, 404; 604 and 405; 605. Moreover, the third action 403; 603 producing a filtered restriction list FRL may be performed at any time once the second action 402; 602 has been performed providing information indicative of the topology data TD from the source radio access node to the network mobility management node. Similarly, the fifth action 405; 605 making a handover decision based of the filtered restriction list 405; 605 may be performed at any time once the fourth action 404; 604 has been performed providing information indicative of the filtered restriction list FRL from the network mobility management node to the source radio access node. The handover decision procedure 405; 605 or parts thereof may be performed a rather long time after the filtered restriction list FRL has been received. However, some embodiments may have the handover decision procedure 405; 605 or parts thereof performed in connection with or at the same time as the fourth action 404; 604.

The exemplifying embodiments discussed above may be summarised in the following way:

Some embodiments are directed to a method in a source radio access node for executing a handover of a radio terminal to a target neighboring radio access node from the source radio access node being controlled by a mobility management node. The method comprises the actions of: obtaining topology data TD comprising information indicative of at least one neighboring radio access node that is neighboring with respect to the source radio access node; providing the topology data TD to the mobility management node; receiving from the mobility management node a filtered restriction list FRL comprising information indicative of at least one restricted neighboring radio access node for the radio terminal, enabling a handover decision to be made based on the filtered restriction list FRL.

The method may comprising the steps of: making a handover decision based on the filtered restriction list FRL at a handover attempt to a target neighboring radio access node such that the attempt is aborted when the target neighboring radio access node is indicated in the filtered restriction list FRL and approved for further processing when the target neighboring radio access node is not indicated in the filtered restriction list FRL.

In the method at least a part of the topology data TD may be obtained by the source radio access node using at least one communication interface connecting the source radio access node to at least one neighboring radio access node; or at least a part of the topology data TD may be obtained by the source radio access node accessing topology data TD that is pre stored in the source radio access node; or at least a part of the topology data TD may be obtained by the source radio access node receiving measurement reports comprising topology data TD obtained by and transmitted from the radio terminal.

In the method the topology data TD may be provided to the mobility management node before or in connection with the radio terminal entering a connected state with respect to the source radio access node that enables the source radio access node to fully or partly control the mobility of the radio terminal.

The method may comprise the steps of providing the topology data TD to the mobility management node in connection with: the source radio access node detecting a difference between the topology data TD most recently obtained and a topology data TD′ previously obtained; or an attach procedure wherein the source radio access node performs an attach for the radio terminal; or a service request procedure wherein the source radio access node enables reception of pending signaling from the radio terminal or transmission of pending signaling or pending user data to the radio terminal; or a tracking area update procedure wherein the source radio access node performs an update of a tracking area TA for the radio terminal; or a routing area update procedure wherein the source radio access node performs an update of a routing area RA for the radio terminal; or a location area update procedure wherein the source radio access node performs an update of a location area LA for the radio terminal; or a handover procedure wherein the radio terminal is handed over to the source radio access node from an originating radio access node.

Before proceeding it may be added that when the topology data TD is only provided to the mobility management node when the source radio access node detects a difference between the recent topology data TD and a previous topology data TD′, this will decrease the number of messages transmitted from the source radio access node to the mobility management node. It may also be noted that the attach procedure, service request procedure, tracking area update procedure, routing area update procedure or location area update procedure mentioned above may e.g. cause the radio terminal to enter a connected state with respect to the source radio access node.

The method may comprise the steps of: providing the topology data TD to the mobility management node in an Initial UE Message, or a Path Switch Request message or a Handover Request Acknowledge message or a Relocation Request Acknowledge message. The Initial UE message may be used in connection with the attach procedure or the service request procedure or the tracking area update procedure or the routing area update procedure or the location area update procedure. The Path Switch Request message or the Handover Request Acknowledge message or the Relocation Request Acknowledge message or similar may be used in connection with the handover procedure.

The method may comprise the steps of receiving the filtered restriction list FRL from the mobility management node in connection with: an attach procedure wherein the radio terminal enters a connected state with respect to the source radio access node; or a service request procedure wherein the source radio access node enters a connected state with respect to the source radio access node; or a tracking area update procedure wherein the source radio access node performs an update of the tracking area TA for the radio terminal; or a handover procedure wherein the radio terminal is handed over to the source radio access node from an originating radio access node.

The method may comprise the steps of receiving the filtered restriction list FRL from the mobility management node in an Initial Context Setup Request message, or a RAB Assignment Request message or a Path Switch Request Acknowledge message.

Some other embodiments are directed to a source radio access node being controlled by a mobility management node and configured to operatively execute a handover of a radio terminal to a target neighboring radio access node from the source radio access node wherein: an obtaining unit is configured to operatively obtain topology data TD comprising information indicative of at least one neighboring radio access node that is neighboring with respect to the source radio access node, and a providing unit is configured to operatively provide the topology data to the mobility management node, and a receiving unit is configured to operatively receive from the mobility management node a filtered restriction list FRL comprising information indicative of at least one restricted neighboring radio access node for the radio terminal, enabling a handover decision to be made based on the filtered restriction list FRL.

The source radio access node may comprise a handover decision unit configured to operatively make a handover decision based on the filtered restriction list FRL at a handover attempt to a target neighboring radio access node such that the attempt is aborted when the target neighboring radio access node is indicated in the filtered restriction list FRL and approved for further processing when the target neighboring radio access node is not indicated in the filtered restriction list FRL.

The obtaining unit may be configured to operatively, obtain at least a part of the topology data TD using at least one communication interface connecting the source radio access node to at least one neighboring radio access node; or to obtain at least a part of the topology data TD by accessing topology data TD that is pre stored in the source radio access node; or to obtain at least a part of the topology data TD by receiving measurement reports comprising topology data TD obtained by and transmitted from the radio terminal.

The providing unit may be configured to operatively provide the topology data TD to the mobility management node before or in connection with the radio terminal entering a connected state with respect to the source radio access node enabling the source radio access node to fully or partly control the mobility of the radio terminal.

The providing unit may be configured to operatively provide the topology data TD to the mobility management node in connection with: detecting a difference between the topology data TD most recently obtained and a topology data TD′ previously obtained; or an attach procedure wherein the source radio access node performs an attach for the radio terminal; or a service request procedure wherein the source radio access node enables reception of pending signaling from the radio terminal or transmission of pending signaling or pending user data to the radio terminal; or a tracking area update procedure wherein the source radio access node performs an update of a tracking area TA for the radio terminal; or a routing area update procedure wherein the source radio access node performs an update of a routing area RA for the radio terminal; or a location area update procedure wherein the source radio access node performs an update of a location area LA for the radio terminal; or a handover procedure wherein the radio terminal is handed over to the source radio access node from an originating radio access node.

The providing unit may be configured to operatively provide the topology data TD to the mobility management node in: an Initial UE Message, or a Path Switch Request message or a Handover Request Acknowledge message or a Relocation Request Acknowledge message.

The receiving unit may be configured to operatively receive the filtered restriction list FRL from the mobility management node in connection with: an attach procedure wherein the radio terminal enters a connected state with respect to the source radio access node; or a service request procedure wherein the source radio access node enters a connected state with respect to the source radio access node; or a tracking area update procedure wherein the source radio access node performs an update of the tracking area TA for the radio terminal; or a handover procedure wherein the radio terminal is handed over to the source radio access node from an originating radio access node.

The receiving unit may be configured to operatively receive the filtered restriction list FRL from the mobility management node in an Initial Context Setup Request message, or a RAB Assignment Request message or a Path Switch Request Acknowledge message. For example, the radio terminal may be a mobile station, MS or an user equipment, UE; and the source radio access node may be a radio network controller, RNC or a base station controller, BSC or an evolved NodeB, eNB; and the mobility management node may be a mobile switching center, MSC or a serving GPRS support node, SGSN or a mobility management entity, MME. An UE corresponds to a MS within GSM and WCDMA and EDGE and GPRS and HSPA. A MME corresponds to a MSC in circuit switched within GSM/WCDMA, and the MME corresponds to a SGSN in packet switch within GSM/WCDMA/EDGE/GPRS/HSPA.

In addition, some other embodiments are directed to a mobility management node configured to operatively manage a handover of a radio terminal from a source radio access node to a target neighboring radio access node, wherein a receiving unit is configured to operatively receive topology data TD from the source radio access node comprising information indicative of at least one neighboring radio access node that is neighboring with respect to the source radio access node; and a producing unit is configured to operatively produce, based on the topology data TD, a filtered restriction list FRL comprising information indicative of at least one restricted neighboring radio access node for the radio terminal; and a providing unit is configured to operatively provide the filtered restriction list FRL to the source radio access node so as to enable the source radio access node to make a handover decision based on the filtered restriction list FRL.

The mobility management node may be a mobile switching center, MSC or a serving GPRS support node, SGSN or a mobility management entity, MME.

The present invention has now been described with reference to exemplifying embodiments. However, the invention is not limited to the embodiments described herein. On the contrary, the full extent of the invention is only determined by the scope of the appended claims.

### ABBREVIATIONS

### CN Core Network

### eNB Evolved Node B

### EDGE Enhanced Data Rates for GSM Evolution

### EPC Evolved Packet Core

### EPS Evolved Packet System

### E-UTRAN Evolved UTRAN

### FRL Filtered Restriction List

### GERAN GSM EDGE Radio Access Network

### GPRS General Packet Radio Service

### GSM Global System for Mobile Communications

### HSS Home Subscriber Server

### HSPA High-Speed Packet Access

### LA Location Area

### LACF Location Area Code

### LTE Long Term Evolution

### IP Internet Protocol

### MiFi Mobile WiFi

### MSC Mobile Switching Center

### MME Mobility Management Entity

### PCRF Policy and Charging Rules Function

### PCEF Policy and Charging Enforcement Function

### PDN Packet Data Network

### PDP Packet Data Protocol

### PGW PDN Gateway

### PLMN Public Land Mobile Network

### RA Routing Area

### RAB Radio Access Bearer

### SGSN Serving GPRS Support Node

### SGW Serving Gateway

### TA Tracking Area

### TAC Tracking Area Code

### UE User Equipment

### UMTS Universal Mobile Telecommunications System

### UTRAN Universal Terrestrial Radio Access Network

WiMAX Worldwide Interoperability for Microwave Access

1. A method in a source radio access node for executing a handover of a radio terminal to a target neighboring radio access node from the source radio access node, comprising:
obtaining topology data (TD) comprising information indicative of at least one neighboring radio access node that is neighboring with respect to the source radio access node,
providing the topology data to a mobility management node in connection with the radio terminal entering a connected state with respect to the source radio access node that enables the source radio access node to fully or partially control the mobility of the radio terminal,
receiving from the mobility management node a filtered restriction list (FRL) comprising information indicative of at least one restricted neighboring radio access node for the radio terminal, and
enabling a handover decision to be made based on the filtered restriction list (FRL).

2. The method according to claim 1, further comprising:
making a handover decision based on the filtered restriction list (FRL) at a handover attempt to a target neighboring radio access node such that the attempt is aborted when the target neighboring radio access node is indicated in the filtered restriction list (FRL) and approved for further processing when the target neighboring radio access node is not indicated in the filtered restriction list (FRL).

3. The method according to claim 1, wherein:
at least a part of the topology data (TD) is obtained by the source radio access node using at least one communication interface connecting the source radio access node to at least one neighboring radio access node; or
at least a part of the topology data (TD) is obtained by the source radio access node receiving measurement reports comprising topology data (TD) obtained by and transmitted from the radio terminal.

4. (canceled)

5. The method according to claim 1, wherein the step of
providing the topology data (TD) to the mobility management node is performed in connection with;
the source radio access node detecting a difference between the topology data (TD) most recently obtained and a topology data (TD′) previously obtained, or
an attach procedure wherein the source radio access node performs an attach for the radio terminal, or
a service request procedure wherein the source radio access node enables reception of pending signaling from the radio terminal or transmission of pending signaling or pending user data to the radio terminal, or
a tracking area update procedure wherein the source radio access node performs an update of a tracking area (TA) for the radio terminal, or
a routing area update procedure wherein the source radio access node performs an update of a routing area (RA) for the radio terminal, or
a location area update procedure wherein the source radio access node performs an update of a location area (LA) for the radio terminal, or
a handover procedure wherein the radio terminal is handed over to the source radio access node from an originating radio access node.

6. The method according to claim 1, wherein the step of providing the topology data (TD) to the mobility management node (MMN) comprises providing the TD to the MMN in: an Initial UE Message, a Path Switch Request message, a Handover Request Acknowledge message, or a Relocation Request Acknowledge message.

7. The method according to claim 1, wherein the source radio access nodes receives the FRL from the mobility management node in connection with:
an attach procedure wherein the radio terminal enters a connected state with respect to the source radio access node, or
a service request procedure wherein the source radio access node enters a connected state with respect to the source radio access node, or
a tracking area update procedure wherein the source radio access node performs an update of the tracking area (TA) for the radio terminal, or
a handover procedure wherein the radio terminal is handed over to the source radio access node from an originating radio access node.

8. The method according to claim 1, wherein the step of receiving the FRL from the mobility management node (MMN) consists of receiving from the MMN an Initial Context Setup Request message that includes the FRL, a RAB Assignment Request message that includes the FRL, or a Path Switch Request Acknowledge message that includes the FRL.

9. The method according to claim 1, wherein:
the radio terminal is a mobile station (MS) or a user equipment (UE),
the source radio access node is a radio network controller (RNC), a base station controller (BSC), or an evolved NodeB (eNB), and
the mobility management node is a mobile switching center (MSC), a serving GPRS support node (SGSN), or a mobility management entity (MME).

10. A source radio access node being controlled by a mobility management node and configured to operatively execute a handover of a radio terminal to a target neighboring radio access node from the source radio access node, comprising:
an obtaining unit that is configured to operatively obtain topology data (TD) comprising information indicative of at least one neighboring radio access node that is neighboring with respect to the source radio access node,
a providing unit that is configured to operatively provide the topology data to the mobility management node in connection with the radio terminal entering a connected state with respect to the source radio access node that enables the source radio access node to fully or partially control the mobility of the radio terminal,
a receiving unit that is configured to operatively receive from the mobility management node a filtered restriction list (FRL) comprising information indicative of at least one restricted neighboring radio access node for the radio terminal, and
a handover decision unit that is configured to operatively make a handover decision based on the filtered restriction list (FRL).

11. The source radio access node according to claim 10, wherein:
the handover decision unit is configured to operatively make a handover decision based on the filtered restriction list (FRL) at a handover attempt to a target neighboring radio access node such that the attempt is aborted when the target neighboring radio access node is indicated in the filtered restriction list (FRL) and approved for further processing when the target neighboring radio access node is not indicated in the filtered restriction list (FRL).

12. The source radio access node according to claim 10, wherein:
the obtaining unit is configured to operatively;
obtain at least a part of the topology data (TD) using at least one communication interface connecting the source radio access node to at least one neighboring radio access node; or
obtain at least a part of the topology data (TD) by receiving measurement reports comprising topology data (TD) obtained by and transmitted from the radio terminal.

13. (canceled)

14. The source radio access node according to claim 10, wherein:
the providing unit is configured to operatively provide the topology data (TD) to the mobility management node in connection with;
detecting a difference between the topology data (TD) most recently obtained and a topology data (TD′) previously obtained, or
an attach procedure wherein the source radio access node performs an attach for the radio terminal, or
a service request procedure wherein the source radio access node enables reception of pending signaling from the radio terminal or transmission of pending signaling or pending user data to the radio terminal, or
a tracking area update procedure wherein the source radio access node performs an update of a tracking area (TA) for the radio terminal, or
a routing area update procedure wherein the source radio access node performs an update of a routing area (RA) for the radio terminal, or
a location area update procedure wherein the source radio access node performs an update of a location area (LA) for the radio terminal, or
a handover procedure wherein the radio terminal is handed over to the source radio access node from an originating radio access node.

15. The source radio access node according to claim 10, wherein the providing unit is configured to operatively provide the topology data (TD) to the mobility management node in: an Initial UE Message, or a Path Switch Request message or a Handover Request Acknowledge message or a Relocation Request Acknowledge message.

16. The source radio access node according to claim 10, wherein
the receiving unit is configured to operatively receive the filtered restriction list (FRL) from the mobility management node in connection with;
an attach procedure wherein the radio terminal enters a connected state with respect to the source radio access node, or
a service request procedure wherein the source radio access node enters a connected state with respect to the source radio access node, or
a tracking area update procedure wherein the source radio access node performs an update of the tracking area (TA) for the radio terminal, or
a handover procedure wherein the radio terminal is handed over to the source radio access node from an originating radio access node.

17. The source radio access node according to claim 10, wherein:
the receiving unit is configured to operatively receive the filtered restriction list (FRL) from the mobility management node in an Initial Context Setup Request message, a RAB Assignment Request message, or a Path Switch Request Acknowledge message.

18. The source radio access node according to claim 10, wherein:
the radio terminal is a mobile station, MS or an user equipment, UE and the source radio access node is a radio network controller, RNC or a base station controller, BSC or an evolved NodeB, eNB and the mobility management node is a mobile switching center, MSC or a serving GPRS support node, SGSN or a mobility management entity, MME.

19. A mobility management node configured to operatively manage a handover of a radio terminal from a source radio access node to a target neighboring radio access node, comprising:
a receiving unit that is configured to operatively receive topology data (TD) from the source radio access node comprising information indicative of at least one neighboring radio access node that is neighboring with respect to the source radio access node,
a producing unit that is configured to operatively produce, based on the topology data (TD), a filtered restriction list (FRL) comprising information indicative of at least one restricted neighboring radio access node for the radio terminal, and
a providing unit that is configured to operatively provide the filtered restriction list (FRL) to the source radio access node so as to enable the source radio access node to make a handover decision based on the filtered restriction list (FRL).

20. The mobility management node according to claim 19, wherein:
the mobility management node is a mobile switching center, MSC, a serving GPRS support node, SGSN, or a mobility management entity, MME.
